(19) United States
(12) Patent Application Publication
(10) Pub. No.: US 2016/0301982 A1
(43) Pub. Date: Oct. 13, 2016

(54) SMART TV MEDIA PLAYER AND CAPTION PROCESSING METHOD THEREOF, AND SMART TV

(71) Applicant: LE SHI ZHI XIN ELECTRONIC TECHNOLOGY (TIANJIN) LIMITED, Beijing (CN)

(72) Inventors: Peng HUANG, Beijing (CN); Yonghui TONG, Beijing (CN)

(21) Appl. No.: 15/036,378

(22) PCT Filed: Nov. 12, 2014
(86) PCT No.: PCT/CN2014/090918

§ 371 Date: May 12, 2016

(30) Foreign Application Priority Data
Nov. 15, 2013 (CN) 201310568359.4

(51) Int. Cl. H04N 21/488; H04N 21/472; H04N 21/854; H04N 21/234; H04N 21/43; H04N 21/643

(52) U.S. Cl. CPC H04N 21/4884; H04N 21/4307; H04N 21/64322; H04N 21/85406; H04N 21/23424; H04N 21/472

(57) ABSTRACT

Method includes: after reading and decoding media information to be played, saving the decoded data flow obtained into a play buffer; searching for and parsing a caption file corresponding to the media information to be played; according to a matching degree of the caption file with the media information to be played and a media player platform, determining a caption file to be merged; according to preset caption display parameters of the media player, superimposing a decoded caption content of the caption file to be merged into the decoded data flow at the corresponding time to generate a merged data flow; and playing and outputting the merged data flow. An embodiment of the present disclosure can effectively control caption content to be displayed in an optimal effect, thus solving the problem of poor user experience due to poor caption display effect of existing media players. A smart TV and a media player are also disclosed.

### FIELD OF TECHNOLOGY

The present disclosure relates to the field of Smart TV media playing, and in particular to a smart TV media player and a caption processing method thereof, and a smart TV.

### BACKGROUND

A smart TV is a smart multimedia terminal emerging by conforming to the trends of high definition, networking and intelligence of televisions, and has functions of acquiring program contents from a plurality of channels such as Internet, video apparatuses and computers, and clearly displaying the contents most needed by a consumer on a large screen through a simple and easy-to-use integrated operation interface. Compared with an application platform of traditional TVs, smart TVs can realize various application services such as network searching, network TV, video-on-demand (VOD), digital music, Network news and network video calls. Televisions are becoming information access terminals of a third type following computers and mobile phones, and a user can access to own desired information anytime. A smart TV, just like a smart phone, is provided with a full-open platform carrying an operating system (for example, an Android system), and a user can install and uninstall programs by himself, such as software and games, provided by third-party service providers, thereby extending functions of the television and continuously providing rich personalized experience for the user.

A smart TV media player is a device capable of playing network streaming media and local audio and video files on a television and realizing perfect sharing of network resources, such that a whole family can enjoy wonderful and happy moments together in front of the television. Captions, serving as important auxiliary information of various media, play an important role in enhancing use experience of users. In the production process of an existing audio/video file or a streaming media resource, caption information needing to be merged will be determined according to parameters such as major audiences and characteristics (such as an output resolution) of a media player of the audio/video file or the streaming media resource, and media formats frequently used by major market objects (for example, video formats such as RM, RMVB, MPEG-1/2, DAT, AVI, DIVX, XVID and VOB, and audio formats such as MP3, WMA and OGG), such that an optimal viewing effect of the produced audio/video file or streaming media resource is achieved.

Generally, for existing media players, supportable media formats and output resolutions are selected according to characteristics of major users of the products; however, due to varied sources of media playing resources in smart TVs, for media different in output resolution, it certainly will have problems of poor display effects such as too large or too small caption font, incomplete display, unclear font, and font color and picture color similar to each other, leading to certain negative effects on watching experience of users.

### SUMMARY

One purpose of a caption processing method of a smart TV media player is to solve the problem of poor caption display effects in a process of playing media data different in output resolution by existing media players.

One purpose of a smart TV and a media player thereof is to guarantee a practical application of the method.

A caption processing method of a smart TV media player includes: after reading and decoding media information to be played, saving the decoded data flow obtained into a play buffer; searching for and parsing a caption file corresponding to the media information to be played; according to a matching degree of the caption file with the media information to be played and a media player platform, determining a caption file to be merged; according to preset caption display parameters of the media player, superimposing a decoded caption content of the caption file to be merged into the decoded data flow at the corresponding time to generate a merged data flow, wherein the caption display parameters include resolution, font size, font color and caption display position; and playing and outputting the merged data flow.

A computer-readable recording medium on which a program for executing the method is recorded is provided.

Preferably, a method of searching for the caption file corresponding to the media information to be played at least include one of the following three methods: regarding a caption file having a file principal name the same as a name of the media information to be played as an associated caption file of the media information to be played; regarding a caption file having a file name containing the name of the media information to be played as an associated caption file of the media information to be played; and regarding a caption file having a file content containing the name of the media information to be played as an associated caption file of the media information to be played.

Preferably, the according to the matching degree of the caption file with the media information to be played and the media player platform, determining the caption file to be merged specifically includes: judging whether the caption file is perfectly matched with the media information to be played and the media player platform; and if so, regarding the perfectly matched caption file as the caption file to be merged, and otherwise, arranging caption files in an order from a high matching degree to a low matching degree, reminding a user of selecting and regarding a caption file selected by the user as the caption file to be merged.

Preferably, the according to the matching degree of the caption file with the media information to be played and the media player platform, determining the caption file to be merged specifically includes: judging whether the caption file is perfectly matched with the media information to be played and the media player platform; and if so, regarding the perfectly matched caption file as the caption file to be merged, and otherwise, selecting a caption file having the highest matching degree as the caption file to be merged.

Preferably, a method of judging the matching degree of the caption file with the media information to be played and the media player platform specifically includes: according to a matching degree between and preset weight ratios of a principal name of the caption file and the media information to be played and according to a matching degree and preset weight ratios of a suffix name and a second suffix name of the caption file, and the media player platform, calculating a degree value of matching of the caption file, wherein a greater degree value of matching indicates a higher matching degree of the caption file, and a full-score degree value of matching indicates perfect matching.

Preferably, a method of calculating the matching degree value of the caption file specifically includes: judging whether the principal name of the caption file is the same as or in an inclusion relation with the name of the media information to be played, and looking up in an association comparison table of the principal names of the caption file and the media information to be played according to a judgment result to obtain a principal name weight value of the caption file; according to the suffix name and the second suffix name of the caption file, obtaining a corresponding suffix name weight value and a second suffix name weight value from an association comparison table of caption file types and the media player platform and an association comparison table of caption file language classes and the media player platform, respectively; and regarding an accumulated value of the principal name weight value, the suffix name weight value and the second suffix name weight value as the matching degree value of the caption file.

Preferably, the caption processing method further includes a dynamic adjustment process for the weight values of the principal name, the suffix name and the second suffix name of the caption file, wherein the dynamic adjustment process specifically includes: performing classified statistics on the number of caption files selected by a user within a period of time according to whether the principal name of the caption file is the same as or in an inclusion relationship with the name of the media information to be played, and according to suffix names and second suffix names of caption files, and adding 5-20 to a weight value of an item exceeding a preset threshold.

Preferably, the caption processing method further includes: receiving caption display parameters selected or input by the user and regarding the caption display parameters as new preset caption display parameters.

A smart TV media player includes: a media acquiring module configured to save decoded data flow obtained into a play buffer after reading and decoding media information to be played; a caption searching and parsing module configured to search for and parse a caption file corresponding to the media information to be played; a matching judgment module configured to determine a caption file to be merged according to a matching degree of the caption file with the media information to be played and a media player platform; a media merging module configured to superimpose a decoded caption content of the caption file to be merged into the decoded data flow at the corresponding time to generate a merged data flow according to preset caption display parameters of the media player, wherein the caption display parameters include resolution, font size, font color and caption display position; and a media playing module configured to play and output the merged data flow.

Preferably, the matching judgment module specifically includes: a judgment module configured to judge the matching degree of the caption file with the media information to be played and the media player platform; a user selection module configured to arrange caption files in an order from a high matching degree to a low matching degree according to an output result of the judgment module, and remind and receive selection of a user; and a first matching module configured to determine the caption file to be merged according to a judgment result of the judgment module, wherein when the caption file is perfectly matched with the media information to be played and the media player platform, the perfectly matched caption file is regarded as the caption file to be merged; when the caption file is not perfectly matched with the media information to be played and the media player platform, the user selection module is called to receive the selection of the user and a caption file selected by the user is regarded as the caption file to be merged.

Preferably, the matching judgment module specifically includes: a judgment module configured to judge the matching degree of the caption file with the media information to be played and the media player platform; and a second matching module configured to determine the caption file to be merged according to a judgment result of the judgment module, wherein when the caption file is perfectly matched with the media information to be played and the media player platform, the perfectly matched caption file is regarded as the caption file to be merged; when the caption file is not perfectly matched with the media information to be played and the media player platform, a caption file having the highest matching degree is selected as the caption file to be merged.

Preferably, the smart TV media player further includes: a parameter setting module configured to receive caption display parameters selected or input by the user and regard the caption display parameters as new preset caption display parameters.

A smart TV includes any one of the above smart TV media players.

Compared with the prior art, the embodiments of the present disclosure have the following advantages:

By above means, preferred embodiments of the present disclosure, can effectively control the sizes, colors, resolutions and others of captions, such that caption contents can be displayed in an optimal effect, and the problem of bad user experience due to poor caption display effects of the existing media players is solved.

### BRIEF DESCRIPTION OF THE DRAWINGS

FIG. 1 is a flow diagram of one embodiment of a caption processing method of a smart TV media player of the present disclosure;

FIGS. 2-1 and 2-2 are flows of two specific implementation methods of a step S103 in the method embodiment shown in FIG. 1;

FIG. 3 is a structural schematic diagram of a first embodiment of a smart TV media player of the present disclosure; and

FIG. 4 is a structural schematic diagram of a second embodiment of a smart TV media player of the present disclosure.

### DESCRIPTION OF THE EMBODIMENTS

To make the purposes, features and advantages of the present disclosure more obvious and understandable, the present disclosure is further described in detail below in combination with accompanying drawings and embodiments.

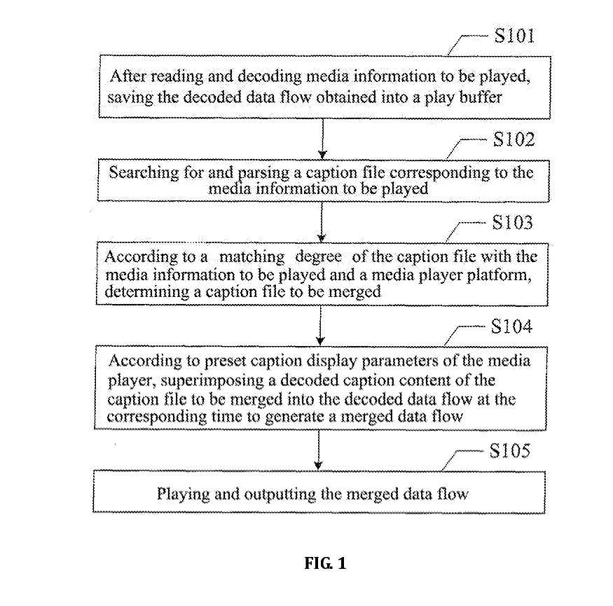

Referring to FIG. 1, it illustrates a flow diagram of one embodiment of a caption processing method of a smart TV media player of the present disclosure, an executive body of which is a media player mounted on a smart TV. The present preferred method embodiment includes the following steps:

Step S101: after reading and decoding media information to be played, the decoded data flow obtained is saved into a play buffer.

In the present preferred embodiment, the media information to be played is an audio/video file locally stored in the smart TV or in an external storage device, or streaming media data stored in a media server.

With respect to the streaming media data stored in the media server, to further enhance watching experience of a user, a segmented downloading mode can be adopted so that the streaming media data can be played while being downloaded (the contents of subsequent segments are downloaded at the same time of playing):

(1) establishing connection to the streaming media server;

(2) reading data of a predetermined size from the streaming media server, and parsing the data of the predetermined size according to a communication protocol of the streaming media server to obtain streaming media parameter information such as a type, a bit rate and a file format of a streaming media;

(3) calculating a size of a buffer area needing to be actually allocated according to the streaming media parameter information and applying for a memory as large as the buffer area to serve as the play buffer; and

(4) reading and decoding a data flow from the streaming media server and then saving the decoded data flow into the play buffer.

Wherein, specifically when the media information to be played is decoded, as media information different in format corresponds to different decoding methods, a format of the media information to be played can be determined firstly before the media information is decoded, and then the media information to be played is decoded according to a decoding mode corresponding to the format. Wherein, the format of the media information to be played can be determined in a plurality of ways; for example, it can be obtained according to a suffix name of the media file to be played or according to related format information (such as file header information) in the media data. It needs to be noted that: the media information to be played generally is dynamic images such as videos, but dynamic images are actually composed of static images arranged frame by frame in a certain time sequence, and in the process of playing, the static images are played in such a time sequence; moreover, due to a quite short time interval between every two frames, a playing effect of continuously dynamic playing is finally achieved. That is to say, as for the media information to be played, information contained therein includes not only data contents (for example, a display content on each pixel, etc.) of each frame of image, but also time information corresponding to each frame of image. Hence, after the media information to be played is decoded, the specific data contents and corresponding time information of each frame of image can be obtained. The time information is of great significance for subsequent steps of merging with a caption file and others in the present embodiment, which will be described in detail later.

Step S102: a caption file corresponding to the media information to be played is searched and displayed.

Generally, the caption file is a file independent of the media information to be played and having a specific file format, for example, SRT, SSA, ASS or SUP or the like, wherein the SRT format and the SSA format are most commonly used; with respect to the SRT format, only simple time codes and text content are presented, but for the SSA format, some special effects can be achieved, for example, specifying font size, font color and realizing some simple animations (rolling, moving, . . . ). In practical application, caption files may be produced by some users themselves; or, there often are providers dedicated to caption file production, etc. In short, for the same media information to be played, there may be a plurality of available caption file in the Internet.

When the media information to be played is the audio/video file locally stored in the smart TV or in the external storage device, associated caption files can be searched in a directory (or subdirectory) where the audio/video file is located or in a caption file storage directory (or subdirectory) set by the media player, and also can be searched in and downloaded from the Internet; certainly, searching can be performed in an order from front to back by the positions until the associated caption files are found out. Additionally, in order to find out one caption file having the highest matching degree with the current media player from numerous caption files, when the caption files are searched, searching can be performed in the various sources, respectively, and the whole caption files found out can be regarded as candidate caption files, and then matching degrees of the candidate caption files with the current media player are judged.

When the media information to be played is the streaming media information stored in the media server, related caption data can be searched in an associated position where the streaming media information is located, and also, associated caption files can be searched in and downloaded from the Internet; searching can be performed in an order from front to back by the positions until the associated caption files are found out. Similarly, searching can be performed in the various sources, respectively, and the whole caption files found out can be regarded as candidate caption files, and then matching degrees of the candidate caption files with the current media player are judged.

A judgment mode for association between the media information to be played and the caption files can be, but is not limited to, the following judgment modes:

A first mode is a file name accurate matching mode, wherein in general case, the caption files may have the same file name body with the media information to be played, and therefore, if the caption files have the same name as the media information to be played, the caption files are regarded as the caption files associated with the media information to be played;

A second mode is a file name fuzzy matching mode, wherein some caption file names may have more content than the file name of the media information to be played; for example, the excessive content is likely to be an identification of a caption language type; for instance, chs represents Chinese Simplified, while cht represents Chinese Traditional and eng represents English caption. For example, the file name of one caption file could be ‘the Good, the Bad and the Ugly.CD1.chs.srt’, while the file name of the media information to be played could be ‘the Good, the Bad and the Ugly.CD1.rmvb’, that is to say, the caption file name is not exactly the same as the file name of the media information to be played, but the file name of the caption file contains the file name of the media information to be played, in this case, the two file names generally correspond to the same video and have an association relationship with each other, and hence, if the file name of one caption file includes the file name of the media information to be played, the caption file is regarded as the caption file associated with the media information to be played; and

A third mode is a content fuzzy matching mode, i.e., if the contents of one caption file include the file name of the media information to be played, the caption file is regarded as the caption file associated with the media information to be played.

Step S103: according to a matching degree of the caption file with the media information to be played and a media player platform, a caption file to be merged is determined.

In the present preferred method embodiment, a method of determining the caption file to be merged can be implemented by using any one of the following solutions:

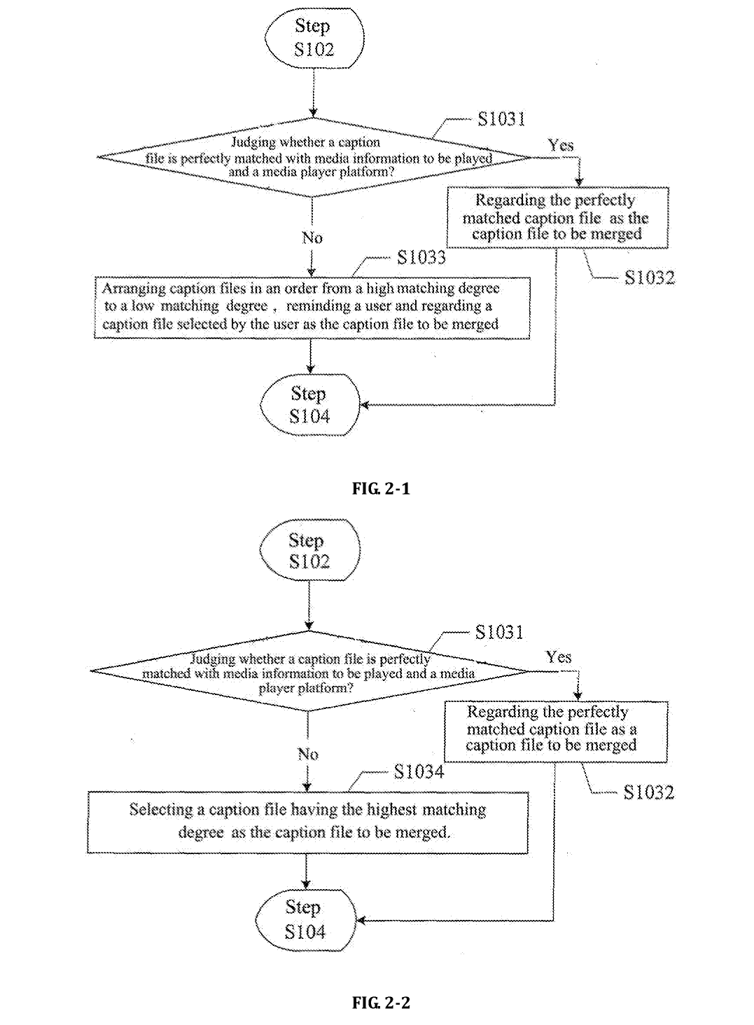

Referring to FIG. 2-1, it illustrates a flow of a specific implementation method of the step S103 in the present preferred method embodiment, specifically including:

S1031: whether the caption file is perfectly matched with the media information to be played and the media player platform is judged; and if so, step S1032 is proceeded, and otherwise, step S1033 is proceeded.

The formats of the caption files can be graphic data formats or text data formats, e.g. SRT(Subripper), SSA(Sub Station Alpha), ASS(Advanced Sub Station Alpha), SMI(Sami), PSB(Power Divx), PJS(Plioenix japanimation), STL(Spruce subtitle file), TTS(Turbo tittle), VSF(Viplay), ZEG(Zero G) and on the like. Caption file language characters include chs, ch, cht, eng etc..

In the present preferred embodiment, the matching degree of the caption file is judged based on a principal name, a suffix name and a second suffix name of the caption file, wherein:

The principal name of the caption file is a character string prior to a first point, while the suffix name of the same is a character string behind a last point and the second suffix name of the same is a character string between the last point and a second last point; if a caption file name contains only one point, the second suffix name of the caption file name is null. For example, the principal name of a caption file ‘Avatar.chs.srt’ is ‘Avatar’, while the suffix name is ‘srt’ and the second suffix name is ‘chs’; the principal name of a caption file ‘Avatar.ssa’ is ‘Avatar’, while the suffix name is ‘ssa’ and the second suffix name is null.

In the present preferred embodiment, a weight ratio of the principal name of the caption file is 50%, while the weight ratio of the suffix name and the second suffix name of the same is 50%. For the sake of convenient calculation, the weight ratios and a weight of a specific item can be directly merged to a weight item under the circumstance of comprehensively considering the weight ratios. A method of calculating a matching degree value of matching is described below in combination with a specific example. In the specific example, the full score of the degree value of matching is 100; weights of corresponding items can be acquired through lookup in the following three comparison tables, and the sum of three weights is regarded as the degree value of matching:

TABLE 1
Association Comparison Table of Principal Names of the Caption
File and the Media Information to Be Played

| Principal name of caption file | Weight |
|---|---|
| Same | 50 |
| The principal name of the caption | 20 |
| file containing the principal name | |
| of the media information to be | |
| played | |
| The principal name of the media | 20 |
| information to be played | |
| containing the principal name of | |
| the caption file | |
| Different and no inclusion | 0 |
| relationship | |

TABLE 2
Association Comparison Table of Caption File Types and Media
Player Platform

| Suffix name of caption file | Weight |
|---|---|
| srt | 30 |
| lrc | 20 |
| ssa | 15 |
| ass | 15 |
| smi | 10 |
| sami | 10 |
| txt | 5 |
| sub | 1 |

TABLE 3
Association Comparison Table of Caption File Language Classes
and the Media Player Platform

| Second suffix name of caption | |
|---|---|
| file | Weight |
| chs | 20 |
| ch | 15 |
| cht | 10 |
| eng | 5 |
| Null | 10 |

Taking a media file ‘Avatar.mp4’ to be played as an example, the degree values of matching of caption files ‘Avatar.srt’, ‘Avatar.chs.srt’, ‘Avatar.ssa’, ‘Avatar.eng.sub’ and ‘Unknown name.ch.srt’ respectively are:

| | | | | Degree value |
|---|---|---|---|---|
| | Table 1 | Table 2 | Table 3 | of Matching |
| Avatar.srt | 50 | 30 | 10 | 90 |
| Avatar.chs.srt | 50 | 30 | 20 | 100 |
| Avatar.ssa | 50 | 15 | 10 | 75 |
| Avatar.eng.sub | 50 | 1 | 5 | 56 |
| Unknown name.ch.srt | 0 | 20 | 15 | 35 |

It needs to be noted that: weight value allocations of the related items in Tables 1-3 are decided by the relevant technical persons with rich experience according to different smart TV platform conditions; to acquire the caption file having the highest matching degree and the optimal caption display effect, the weights of the items also can be manually adjusted by the relevant persons according to use conditions of users in the use process; also, according to the selections of the users to the caption files, Tables 1-3 may be dynamically adjusted in the following manner: if more than a certain proportion (for example, more than 20%) of users select caption files relatively low in matching degree value in a manual manner within a period of time (such as one week), or most users (for example, more than 80% of users) select captions files of which the matching degree values are the greatest but not equal to 100, the present preferred method embodiment will perform classified statistics on the number of caption files selected by the users according to whether the principal names of the caption files are the same as or in the inclusion relationship with the name of the media information to be played, and according to the suffix names and the second suffix names of the caption files, and automatically increase item weight values exceeding a preset threshold (for example, accounting for 50% of the total number of the caption files selected by the users) by 5-20 orders of magnitude (requirement is that the sum of the highest weights of the three comparison tables is 100). Taking the data of Tables 1-3 as an example, if 20% of users select the caption files relatively low in degree value of matching within one week and 50% of caption files among the caption files relatively low in degree value of matching have the suffix of ssa, the system automatically increases the weight of the suffix ssa from 15 to 20.

With regard to which language character code is exactly used by a caption file, in addition to the judgment mode adopted in the above preferred embodiment and using a second suffix name of a file name, the following method also can be adopted for judgment:
(1) presetting a coding value distribution probability table of every character code according to experience (the distribution probability table can be adjusted anytime according to experience accumulation);
(2) counting times of every coding value included in the caption file appearing in the caption file;
(3) counting a probability of every coding value included in the caption file corresponding to every character code according to the preset coding value distribution probability table of every character code and the times of every coding value included in the caption file appearing in the caption file;
(4) calculating a possibility probability of the caption file corresponding to each character code according to the probability of every coding value included in the caption file corresponding to every character code; and
(5) determining the character code having the greatest possibility probability of the caption file as the character code of the caption file.

Step S1032: the perfectly matched caption file is regarded as the caption file to be merged, and a step S104 is proceeded;

Step S1033: caption files are arranged in an order from a high matching degree to a low matching degree, and a user is reminded of selecting, and the caption file selected by the user is regarded as the caption file to be merged; then, the step S104 is proceeded.

In the present embodiment, after the caption file to be merged is determined, if the user selects a caption file relatively low in matching degree, the system may save the selection of the user and preferably load a caption saved by the user last time for playing next time.

Referring to FIG. 2-2, it illustrates a flow of another specific implementation method in the step S103 in the preferred method embodiment; this solution differs from the solution shown in FIG. 2-1 in that: when the caption file is not perfectly matched with the media information to be played and the media player platform, the caption file to be merged is determined by use of the following method:

Step S1034: the caption file having the highest matching degree is selected as the caption file to be merged.

Step S104: according to preset caption display parameters of the media player, a decoded caption content of the caption file to be merged is superimposed to the decoded data flow at the corresponding time to generate a merged data flow.

In specific implementation, the caption display parameters in the media player may be preset; for example, the player provides some default settings after it launches. Or, these parameters also can be altered by users according to their own requirements.

The caption display parameters include resolution, font size, font color, caption display position etc.. Wherein:

Resolution ratios include: 1920*1080, 1366*768, 1280*720, 848*48 and 640*480.

Front sizes include: large, medium and small.

Font colors include: white, black, grey, yellow, green and blue.

Caption display positions include: transverse display at the bottom of a screen, transverse display at the top of the screen, vertical display on the right of the screen, vertical display on the left side of the screen etc..

Caption files also contain time information, thereby providing basis for merging with the decoded data flow of the media information to be played. For the sake of easy understanding, related concepts of caption files are described simply below. Caption files generally include graphic format captions and text format captions. Wherein, a graphic format caption is composed of idx and a sub file; idx is equivalent to an index file which includes time codes of caption appearing and attributes of caption display therein, while the sub file is caption data itself. Expanded names of the text format captions generally are srt, smi, ssa or sub (they are just like graphic format suffixes, but different in data format), wherein srt text captions are most popular because they can be produced and altered very simply, i.e., one sentence of time codes plus one sentence of caption. For example, with respect to the following srt caption file content:

45

00:02:52,184→00:02:53,617

take your time

It indicates that the 45^{th} row of caption, display time from the time point of 2 minutes and 52.184 seconds to the time point of 2 minutes and 53.617 seconds of an audio/video, with the caption content: take your time.

Hence, in the generation process of the merged data flow, the decoded data flow can be superimposed to the corresponding caption content according to a corresponding relation (for example, time stamps in the data flow and caption content attributes are consistent) between time information contained in the decoded data flow and the caption content, respectively, and caption display parameter attributes.

Step S105, the merged data flow are played and output.

The present preferred method embodiment determines the caption file to be merged according to a matching degree of a character set and a caption format of a caption file with the smart TV media player, and the caption content and the media data flow are merged according to effective display parameters of the media player; the size, color, resolution and others of the caption can be effectively controlled so that the caption content can be displayed in the optimal effect.

In a further preferred embodiment of the present method embodiment, it further includes:

a caption display parameter adjustment step S100: caption display parameters selected or input by a user are received and the caption display parameters are regarded as new preset caption display parameters.

The caption display parameter adjustment step S100 can be executed anytime after the media player is started; after alteration of the caption display parameters takes effect, it can be executed by using any one of the following solutions:

Solution 1, the playing media is executed according to the previous caption display parameters, and the new caption display parameters take effect when next media is played;

Solution 2: subsequent media fragments are dynamically adjusted; for the subsequently displayed media fragments, when the playing data flow is merged, the caption content is superimposed to the decoded data flow at the corresponding time by employing the new adjusted caption display parameters.

With regard to each of the above-mentioned method embodiments, for the sake of simple description, all the method embodiments are expressed as a series of motion combinations; but those skilled in the art should know that the present disclosure is not limited by the described motion order because some steps can be executed in other orders or simultaneously according to the present disclosure; taking the step S103 as an example, the step of searching for and parsing the caption file can be executed after the steps S101 and S102, before the step S101 or between the steps S101 and S102, and further can be executed along with the step S101; secondly, those skilled in the art also should know that the above-mentioned method embodiments are preferred embodiments, and the motions and modules involved therein are not always necessary for the present disclosure.

The present disclosure further discloses a computer-readable recording medium on which a program for executing the method is recorded. The computer-readable recording medium includes any mechanism configured to store or transmit information in a computer (taking the computer as an example)-readable form. For example, a machine-readable medium includes a read-only memory (ROM), a random access memory (RAM), a magnetic disk storage medium, an optical storage medium, a flash storage memory, propagated signals in electrical, optical, acoustical or other forms (i.e., carriers, infrared signals, digital signals, etc.), etc..

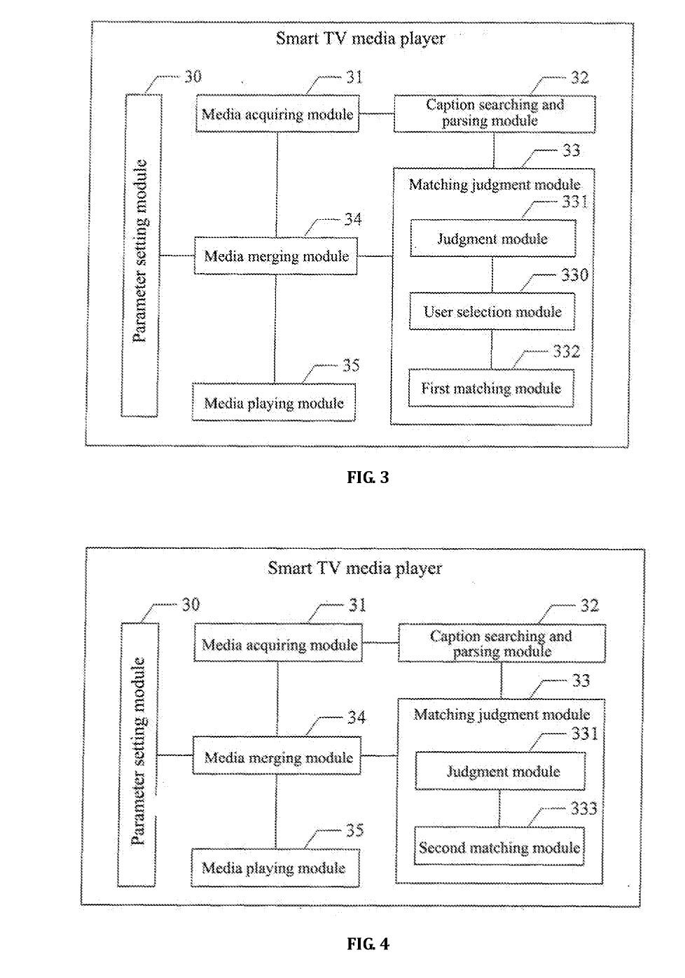

Referring to FIG. 3, it illustrates a structural block diagram of a first embodiment of a smart TV media player of the present disclosure, including a media acquiring module 31, a caption searching and parsing module 32, a matching judgment module 33, a media merging module 34, a media playing module 35, a parameter setting module 30 and on the like, wherein:

The media acquiring module 31 is configured to save decoded data flow obtained into a play buffer after reading and decoding media information to be played.

The caption searching and parsing module 32 is configured to search for and parse a caption file corresponding to the media information to be played.

The matching judgment module 33 is configured to determine a caption file to be merged according to a matching degree of the caption file obtained by the caption searching and parsing module 32 with the media information to be played and a media player platform.

Wherein, the matching judgment module 33 specifically includes:

a judgment module 331 configured to judge the matching degree of the caption file obtained by the caption searching and parsing module 32 with the media information to be played and the media player platform;

a user selection module 330 configured to arrange caption files in an order from a high matching degree to a low matching degree according to an output result of the judgment module 331, and remind and receive selection of a user; and

a first matching module 332 configured to determine the caption file to be merged according to a judgment result of the judgment module 331, wherein when the caption file is perfectly matched with the media information to be played and the media player platform, the perfectly matched caption file is regarded as the caption file to be merged; when the caption file is not perfectly matched with the media information to be played and the media player platform, the user selection module 330 is called to receive the selection of the user and a caption file selected by the user is regarded as the caption file to be merged.

The media merging module 34 is configured to superimpose a decoded caption content of the caption file to be merged into the decoded data flow at the corresponding time to generate a merged data flow according to preset caption display parameters of the media player;

wherein the caption display parameters include resolution, font size, font color and caption display position.

The media playing module 35 is configured to play and output the merged data flow generated by the media merging module 34.

The parameter setting module 30 is configured to receive caption display parameters selected or input by the user and regard the caption display parameters as new preset caption display parameters.

Referring to FIG. 4, it illustrates a structural block diagram of a second embodiment of a smart TV media player of the present disclosure, and this device embodiment differs from the first device embodiment in that the matching judgment module 33 specifically includes the following modules:

a judgment module 331 configured to judge the matching degree of the caption file with the media information to be played and the media player platform; and

a second matching module 333 configured to determine the caption file to be merged according to a judgment result of the judgment module 331, wherein when the caption file is perfectly matched with the media information to be played and the media player platform, the perfectly matched caption file is regarded as the caption file to be merged; when the caption file is not perfectly matched with the media information to be played and the media player platform, a caption file having the highest matching degree is selected as the caption file to be merged.

Additionally, the present disclosure further discloses a smart TV including the media player; the smart TV can play audio and video files stored locally and in an external storage device and streaming media data stored in a media server; the smart TV further includes:

a main chip, which is an integrated smart TV main chip, with a main frequency of not lower than 800 M and an ARM architecture, and including a DSP (video hardware decoding);

a memory, which is a capacity of not less than 256 MB of DDR2;

an internal storage device, which is a Nand flash memory or an EMC flash memory, with the capacity of not less than 2 G;

an external device interface, which includes at least 4 USB interfaces, such that a USB flash disk, a mobile hard disk, a keyboard, a mouse, a wireless keyboard & mouse receiver, a WIH wireless network card, a game pad and others can be connected;

a remote controller, which at least includes keys such as up, down, left, right, confirm, return, menu, home, 0-9 number keys etc.; and

a liquid crystal display screen with a resolution of not less than 1280*720.

It needs to be noted that the device embodiment is a preferred embodiment and modules involved therein are not always necessary for the present disclosure.

Each embodiment in this description is described in a progressive manner, and in each embodiment, the differences between the embodiment and other embodiments are mainly explained; the same and similar parts of the various embodiments refer to each other. The device embodiments of the present disclosure are just simply described because they are substantially similar to the method embodiments, and correlations therebetween just refer to one part of descriptions of the method embodiments.

The smart TV media player and the caption processing method thereof, and the smart TV, all provided by the present disclosure, are described in detail above. In this text, specific examples are utilized to explain the principles and the implementation modes of the present disclosure, and the foregoing descriptions of the embodiments are merely used for helping to understand the method of the present disclosure and the main ideas thereof; meanwhile, for those ordinary skilled in the art, alterations will be made to the specific implementation manners and the application range according to the ideas of the present disclosure; in conclusion, the content of the description should not be understood as limitations to the present disclosure.

1. A caption processing method of a smart TV media player, comprising:
after reading and decoding media information to be played, saving the decoded data flow obtained into a play buffer;
searching for and parsing a caption file corresponding to the media information to be played;
according to a matching degree of the caption file with the media information to be played and a media player platform, determining a caption file to be merged;
according to the presetting caption display parameters of the media player, superimposing a decoded caption content of the caption file to be merged into the decoded data flow at the corresponding time to generate a merged data flow, wherein the caption display parameters comprise resolution, font size, font color and caption display position; and
playing and outputting the merged data flow.

2. The caption processing method of the smart TV media player of claim 1, wherein a method of searching for the caption file corresponding to the media information to be played at least comprise one of the following three methods:
regarding a caption file having a file principal name the same as the name of the media information to be played as an associated caption file of the media information to be played;
regarding a caption file having a file name containing the name of the media information to be played as an associated caption file of the media information to be played; and
regarding a caption file having a file content containing the name of the media information to be played as an associated caption file of the media information to be played.

3. The caption processing method of the smart TV media player of claim 1, wherein the according to the matching degree the caption file with the media information to be played and the media player platform, determining the caption file to be merged, specifically comprises:
judging whether the caption file is perfectly matched with the media information to be played and the media player platform; and
if so, regarding the perfectly matched caption file as the caption file to be merged, and otherwise, arranging caption files in an order from a high matching degree to a low matching degree, reminding users of selecting, and regarding the caption file selected by the user as the caption file to be merged.

4. The caption processing method of the smart TV media player of claim 1, wherein the according to the matching degree of the caption file with the media information to be played and the media player platform, determining the caption file to be merged, specifically comprises:
judging whether the caption file is perfectly matched with the media information to be played and the media player platform; and if so, regarding the perfectly matched caption file as the caption file to be merged, and otherwise, selecting a caption file having the highest matching degree as the caption file to be merged.

5. The caption processing method of the smart TV media player of claim 3, wherein a method of judging the matching degree of the caption file with the media information to be played and the media player platform, specifically comprises:
according to the preset weight value and the matching degree between a principal name of the caption file and the media information to be played, and according to the preset weight value and the matching degree between a suffix name, a second suffix name of the caption file and the media player platform, calculating a matching degree value of the caption file, wherein a greater matching degree value indicates a higher matching degree of the caption file, and a full-score matching degree value indicates perfect matching.

6. The caption processing method of the smart TV media player of claim 5, wherein a method of calculating the matching degree value of the caption file, specifically comprises:
judging whether the principal name of the caption file is the same as or in an inclusion relationship with the name of the media information to be played, and looking up in an association comparison table of the principal names of the caption file and the media information to be played, according to a judgment result to obtain a weight value of the principal name of the caption file;
according to the suffix name and the second suffix name of the caption file, obtaining a corresponding suffix name weight and a second suffix name weight from an association comparison table of caption file types and the media player platform and an association comparison table of caption file language classes and the media player platform, respectively; and
regarding an accumulated value of the principal name weight value, the suffix name weight value and the second suffix name weight value as the matching degree value of the caption file.

7. The caption processing method of the smart TV media player of claim 6, further comprising a dynamic adjustment process for the weight values of the principal name, the suffix name and the second suffix name of the caption file, wherein the dynamic adjustment process specifically comprises:
performing classified statistics on the number of caption files selected by a user within a period of time according to whether the principal name of the caption file is the same as or in an inclusion relationship with the name of the media information to be played, and according to suffix names and second suffix names of caption files, and adding 5-20 to the weight value of an item exceeding a preset threshold.

8. The caption processing method of the smart TV media player of claim 1, further comprising:
receiving caption display parameters selected or input by the user and regarding the caption display parameters as new preset caption display parameters.

9. A smart TV media player, comprising:
a media acquiring module configured to save decoded data flow obtained into a play buffer after reading and decoding media information to be played;
a caption searching and parsing module configured to search for and parse a caption file corresponding to the media information to be played;
a matching judgment module configured to determine a caption file to be merged according to a matching degree of the caption file with the media information to be played and a media player platform;
a media merging module configured to superimpose a decoded caption content of the caption file to be merged into the decoded data flow at the corresponding time to generate a merged data flow according to preset caption display parameters of the media player, wherein the caption display parameters comprise resolution, font size, font color and caption display position; and
a media playing module configured to play and output the merged data flow.

10. The smart TV media player of claim 9, wherein the matching judgment module specifically comprises:
a judgment module configured to judge the matching degree of the caption file with the media information to be played and the media player platform;
a user selection module configured to arrange caption files in an order from a high matching degree to a low matching degree according to an output result of the judgment module, and remind and receive selection of a user; and
a first matching module configured to determine the caption file to be merged according to a judgment result of the judgment module, wherein when the caption file is perfectly matched with the media information to be played and the media player platform, the perfectly matched caption file is regarded as the caption file to be merged; when the caption file is not perfectly matched with the media information to be played and the media player platform, the user selection module is called to receive the selection of the user and a caption file selected by the user is regarded as the caption file to be merged.

11. The smart TV media player of claim 9, wherein the matching judgment module specifically comprises:
a judgment module configured to judge the matching degree of the caption file with the media information to be played and the media player platform; and
a second matching module configured to determine the caption file to be merged according to a judgment result of the judgment module, wherein when the caption file is perfectly matched with the media information to be played and the media player platform, the perfectly matched caption file is regarded as the caption file to be merged; when the caption file is not perfectly matched with the media information to be played and the media player platform, a caption file having the highest matching degree is selected as the caption file to be merged.

12. The smart TV media player of claim 9, further comprising:
a parameter setting module configured to receive caption display parameters selected or input by the user and regard the caption display parameters as new preset caption display parameters.

13. A smart TV, comprising the smart TV media player of claim 12.

14. A computer-readable recording medium on which a program for executing the method of claim 1 is recorded.

15. The caption processing method of the smart TV media player of claim 4, wherein a method of judging the matching degree of the caption file with the media information to be played and the media player platform, specifically comprises:
according to the preset weight value and the matching degree between a principal name of the caption file and the media information to be played, and according to the preset weight value and the matching degree between a suffix name, a second suffix name of the caption file and the media player platform, calculating a matching degree value of the caption file,
wherein a greater matching degree value indicates a higher matching degree of the caption file, and a full-score matching degree value indicates perfect matching.

16. The smart TV media player of claim 10, further comprising:
a parameter setting module configured to receive caption display parameters selected or input by the user and regard the caption display parameters as new preset caption display parameters.

17. The smart TV media player of claim 11, further comprising:
a parameter setting module configured to receive caption display parameters selected or input by the user and regard the caption display parameters as new preset caption display parameters.

18. A smart TV, comprising the smart TV media player of claim 10.

19. A smart TV, comprising the smart TV media player of claim 11.

20. A smart TV, comprising the smart TV media player of claim 12.
